(19) United States
(12) Patent Application Publication
(10) Pub. No.: US 2004/0128371 A1
(43) Pub. Date: Jul. 1, 2004

(54) Personal hand held terminal capable of interfacing information with host and method thereof

(75) Inventors: Han-Sub Park, Anyang-City (KR); Hee-Souk Park, Seoul (KR); Hong-Chan Park, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/689,747

(22) Filed: Oct. 22, 2003

(30) Foreign Application Priority Data
Dec. 31, 2002 (KR) 2002-88234

(51) Int. Cl. G06F 15/177; G06F 15/16

(52) U.S. Cl. 709/221; 709/250

(57) ABSTRACT

A personal hand held terminal has a data sync driver, a USB mass storage driver, and a control section. The control section loads the preset USB mass storage driver or a data sync driver in response to an input command or a request received from a USB host. For example, a system/USB mass storage switchover command is input through a system switchover command key. The control section transmits/receives data to/from the USB host via the USB mass storage driver, if a data transmission/reception request is received from the USB host based on a USB mass storage specification via a USB client interface of the hand held terminal. If the USB host is not provided with a data sync module, it is possible to interface information between both systems, because USB host systems provided with a USB host interface can recognize the personal hand held terminal as a USB mass storage.

### CROSS-REFERENCE TO RELATED APPLICATIONS

This application claims the benefit of Korean Application No. 2002-88234, filed Dec. 31, 2002, in the Korean Intellectual Property Office, the disclosure of which is incorporated herein by reference.

### BACKGROUND OF THE INVENTION

1. Field of the Invention

The present invention relates to a personal hand held terminal, and more particularly, to a personal digital assistant in which the information stored thereon can be arranged to interface with a host system and a method thereof.

2. Description of the Related Art

Sometimes, the personal hand held terminals, such as a personal digital assistant (PDA), download new applications from a personal computer (PC) and install these thereon, or deliver the stored information to other systems, such as the PC. Particularly, the personal hand held terminals have a benefit of having excellent mobility, but there is a need to backup the hand held terminal data in a system which is always stable, because the information stored in the hand held terminal memory can be lost due to the battery capacity limit or an impact to the hand held terminal. In such a case, in order for users to transmit information between the personal hand held terminal and the host, users transmit the information by means of a data synchronization module in both the hand held terminal and the host or an external storage device connected to the hand held terminal. The data synchronization module is a module designed for synchronizing the respective information stored in the personal hand held terminal and the host when both systems are connected.

FIG. 1 is a functional block diagram of a conventional connection system between a personal hand held terminal and a host via a data synchronization module. The personal hand held terminal 10 comprises a control section 12 having a driver manager 12-1; a data synchronization driver 14; and a USB client interface 16. The host comprises a control section 22 having a data synchronization module 22-1, a device manager 22-2, and a driver manager 22-3; a data synchronization driver 24; and a USB host interface 26.

As such, while the personal hand held terminal 10 is interconnected with the host 20, if the data synchronization module 22-1 is selected, the control section 22 of the host 20 loads the data synchronization driver 24 by means of the device manager 22-2 and the driver manager 22-3, and then performs the interfacing and data synchronization with the personal hand held terminal 10.

FIG. 2 is a functional block diagram of a connection system of a hand held terminal 30 and a host 40 according to an embodiment in which external storage devices are used to transmit data between the personal hand held terminal 30 and the host 40. An MMC card 50, a CF card 60, or USB storage media 70, and the like are used as the external storage devices.

As such, when interfacing the information between the personal hand held terminal and the host, the information can be interfaced mainly by using the data synchronization module or the external storage devices as shown in FIGS. 1 and 2, respectively.

However, as described above, to interface the information between the personal hand held terminal and the host, there is a problem that it is possible to interface the data only when the data synchronization module is installed in the host, or the host must be provided with the driver driving the external storage devices. Therefore, if either the data synchronization module or the external storage device driver is not installed in the host, data interfacing between the personal hand held terminal and the host cannot be performed.

### SUMMARY OF THE INVENTION

The present invention provides a personal hand held terminal interfacing data with a host not provided with a data synchronization module, and a method thereof.

Additional aspects and advantages of the invention will be set forth in part in the description which follows and, in part, will be obvious from the description, or may be learned by practice of the invention.

The present invention may be achieved by a personal hand held terminal system comprising a USB mass storage driver; a data synchronization driver; an input section receiving a system switchover command from a user causing the system to be selectively recognized as a USB mass storage in host; a USB interface transmitting/receiving data to/from the host; and a control section selectively loading the USB mass storage driver or the data synchronization driver based on the input system switchover command, thereby controlling the system to transmit/receive data to/from the host according to the loaded driver.

According to an aspect of the invention, if a data transmission/reception request is delivered based on a data synchronization module specification from the host while the system is selected by the input section to operate as the USB mass storage, the control section loads the data synchronization driver. According to an aspect of the invention, the control section may forcibly terminate the driving of the preset USB mass storage driver, or may cause the data synchronization driver to process the data transmission/reception while both the USB mass storage driver and the data synchronization driver are loaded. According to an aspect of the invention, to efficiently manage the system resources, the drive of the USB mass storage driver is forcibly terminated, if a data transmission/reception request is received from the data synchronization module of the host.

According to the above-described personal hand held terminal system of the invention, even the host not provided with the data synchronization module can share data stored in the hand held terminal system, because the user can optionally cause the system to be recognized as the standard USB mass storage device by the host or as the personal hand held terminal system depending on the connected host.

The present invention may also be achieved by a personal hand held terminal system comprising a USB mass storage driver; a data synchronization driver; a USB interface transmitting/receiving data to/from a host; and a control section, the control section selectively loading the USB mass storage driver or the data synchronization driver based on a requested data transmission/reception specification and controlling the system to transmit/receive data to/from the host according to the loaded driver. According to an aspect of the invention, the data transmission/reception request based on the USB mass storage specification and the data synchronization module specification is delivered via the USB interface from the host.

According to the above-described personal hand held terminal system, because the system automatically loads the corresponding driver according to the data transmission/reception specification requested from the host, it is possible to freely share information between the host and the personal hand held terminal system regardless of whether the data synchronization module is installed in the host.

### BRIEF DESCRIPTION OF THE DRAWINGS

The above and/or other aspects and advantages of the invention will become apparent and more readily appreciated from the following description of the embodiments, taken in conjunction with the accompanying drawings of which:

FIG. 1 is a functional block diagram of a conventional data interface connection between a personal hand held terminal and a host.

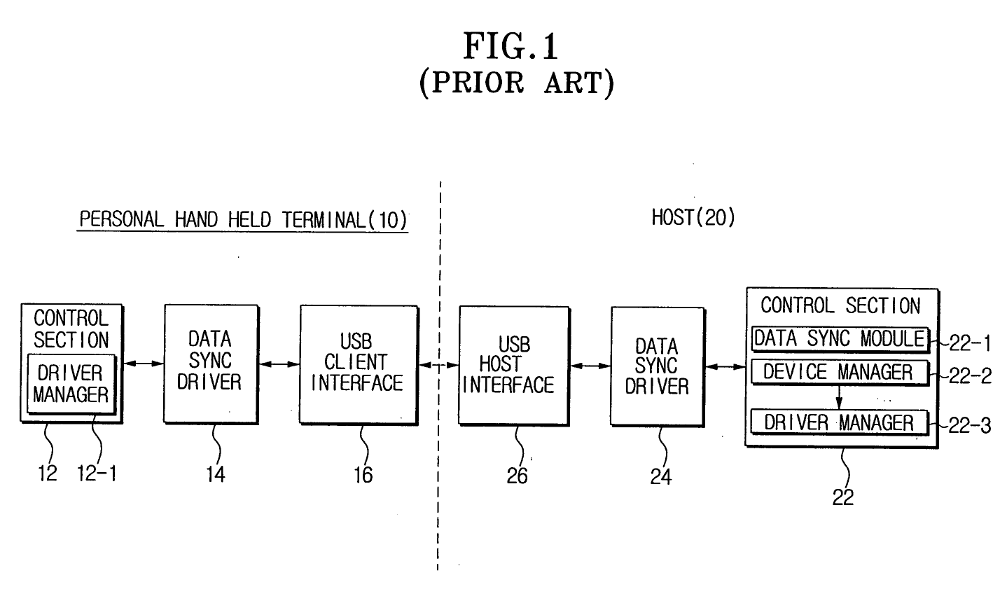

FIG. 2 is a functional block diagram of a conventional data interface connection between a personal hand held terminal and a host using external storage devices.

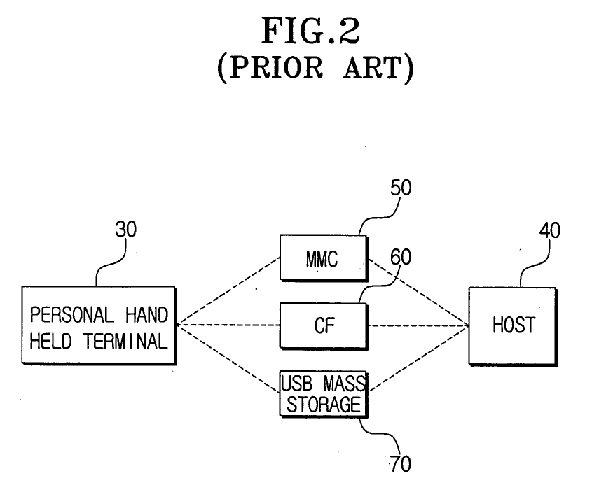

FIG. 3 is a functional block diagram of a data interface connection between a personal hand held terminal and a host, according to an embodiment of the present invention.

FIG. 4 is a flow chart of interfacing data between the personal hand held terminal and the host using the data interface connection shown in FIG. 3, according to an embodiment of the invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

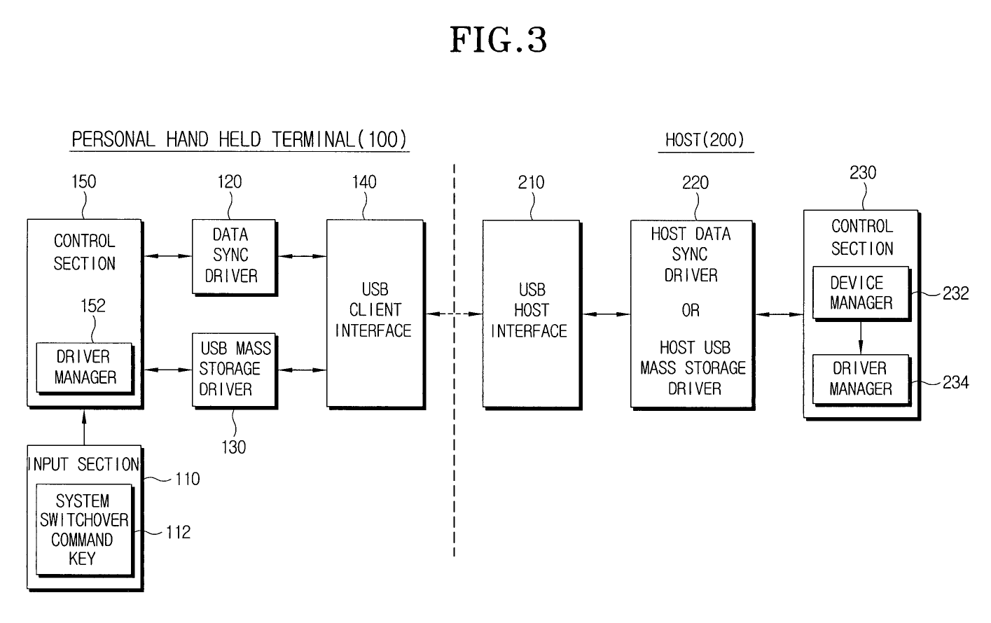

FIG. 3 is functional block diagram of a data interface connection between a personal hand held terminal system and a host, according to an embodiment of the present invention. In FIG. 3, the personal hand held terminal system 100 comprises an input section 110 embodying/implementing a system switchover command key 112; a data synchronization driver 120, a USB mass storage driver 130, a USB client interface 140, which is the standard USB client interface, and a control section 150 embodying/implementing a driver manager 152.

Typically, the input section 110 is a plurality of input keys (not shown) for receiving commands controlling the system operations from a user. Specifically, the input section 110 provides the system switchover command key 112 for receiving commands from the user, causing the system to be selectively operated in a personal hand held terminal mode or a USB mass storage mode.

The data sync driver 120, which, typically is software, is loaded by the driver manager 152 of the control section 150, synchronizing and interfacing data between a host 200 and the system 100 via the standard USB client interface 140. The USB mass storage driver 130, which, typically is software, is also loaded by the driver manager 152 of the control section 150, causing the host 200 to recognize the system 100 as a USB mass storage to interface/exchange data with the system 100 via the standard USB client interface 140.

Therefore, the standard USB client interface 140 is driven by the data sync driver 120 and the USB mass storage driver 130, and performs the data interfacing with the host 200 according to the specification of the selected drivers 120 and 130. Typically, the control section 150 of the personal hand held terminal system 100 controls the whole system 100 (e.g., typically, the control section 150 is a programmed computer processor controlling the overall system operations). The control section 150 switches the system 100 to the personal hand held terminal mode or the USB mass storage mode based on the system switchover command input via the system switchover command key 112 of the input section 110. More particularly, the control section 150 causes the system 100 to exchange/interface data with the host 200 according to the mode selected in response to the system switchover command key 112 of the input section 100.

In FIG. 3, the host 200 may be any host computer system comprising a standard USB host interface stack 210 including a host USB data driver 220, and a control section 230 embodying/implementing a device manager 232 and a driver manager 234 to control the standard USB host interface stack. In particular, the host USB data driver 220 may be implemented as either a host data sync driver 220 or the standard host USB mass storage driver 220 provided within the USB host interface stack 210. As described above, the personal hand held terminal 100 can communicate with the host 200 even if the host 200 does not implement the host data sync driver 220 and only implements the standard USB host interface stack 210 including the host USB mass storage driver 220.

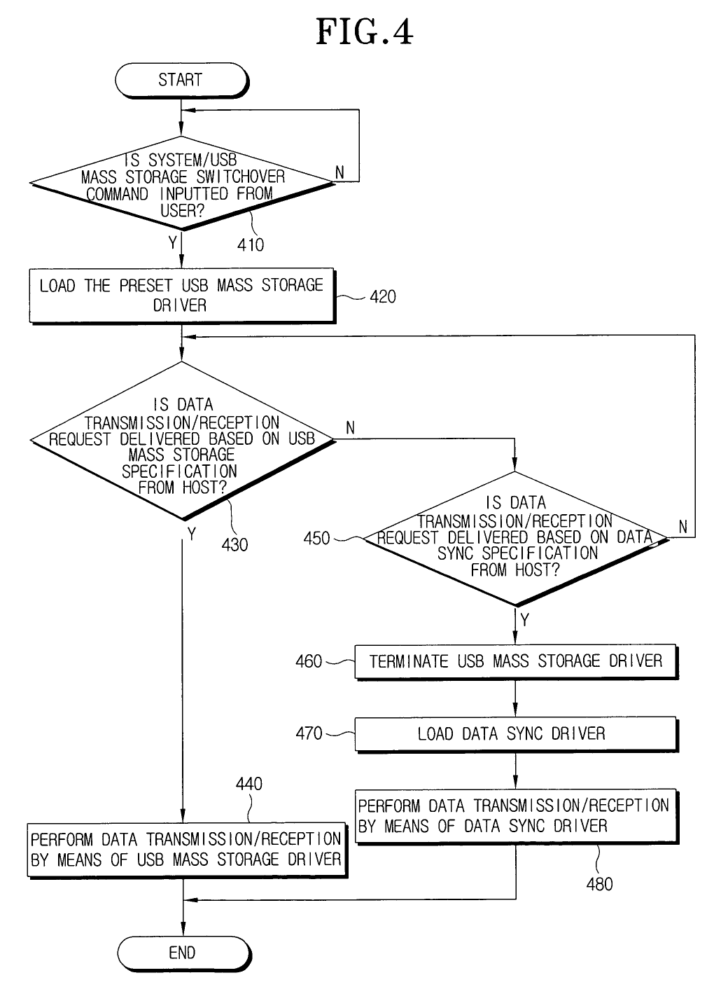

FIG. 4 is a flow chart of interfacing data between the personal hand held terminal and the host using the data interface connection shown in FIG. 3, according to an embodiment of the invention. If determined at operation 410 that a system/USB mass storage switchover command is input to the personal hand terminal system by a user via the system switchover command key 112 of the input section 110, at operation 410, the control section 150 loads a preset USB mass storage driver 130 via the driver manager 152. If determined at operation 430 that a data transmission/reception request is delivered based on a USB mass storage specification via the USB client interface 140 from the host 200, at operation 440, the control section 150 performs the data transmission/reception to/from the host 200 via the loaded preset USB mass storage driver 130.

On the other hand, if determined at operation 430 that the data transmission/reception request is not delivered based upon the USB mass storage specification, operation 450 determines if a data transmission/reception request is delivered based on a data sync specification from the host 200 has been previously loaded by the user at operation 420 to cause the system 100 to operate as a USB mass storage. If operation 450 determines that the transmission/reception request is not delivered based upon the data sync specification, the system processing returns to operation 430 to check another received data transmission/reception request. However, if operation 450 determines that the data transmission/reception request is delivered based upon the data sync specification, at operation 460, the control section 150 terminates the drive of the loaded USB mass storage driver 130. At operation 470, the control section 150 loads the data sync driver 120 via the driver manager 152. According to an aspect of the invention, at operation 470, the control section 150 may not necessarily terminate the previously loaded USB mass storage driver 130, and performs the data transmission/reception via the data sync driver 120 by loading both the USB mass storage driver 130 and the data sync driver 120. However, depending on the system, for example, if the system has a low processing capacity, it may be desirable to terminate the drive of the loaded USB mass storage driver 130 to efficiently manage the resources of the personal hand held terminal having the less capacity. At operation 480, the control section 150 performs the data transmission/reception to/from the host 200 via the loaded data sync driver 120.

As described above, if the user switches the hand held terminal system 100 to the USB mass storage mode and hence the USB mass storage driver 130 is loaded, all host systems 200 provided with the USB host interface 210 recognize the hand held terminal system 100 as a USB mass storage to interface information between the hand held terminal system 100 and the host system 200 via the respective USB mass storage driver 130, the USB client interface 140, the USB host interface 210, and the host USB mass storage driver 220.

According to another aspect of the present invention, it is also possible to implement a data interface between the hand held terminal and the host based on a specification requested from the host without receiving the system switchover command from the user. In other words, the personal hand held terminal system comprises both a data sync driver and a USB mass storage driver, and the control section in the system selectively loads the data sync driver or the USB mass storage driver according to a data transmission/reception specification request from the host. Accordingly, the hand held terminal control section causes the system to interface data with the host via a USB client data driver, which may be a data sync driver or a USB mass storage driver, loaded in response to the host data transmission/reception specification request. Accordingly, it is not necessary to provide in the hand held terminal an input section with a separate system switchover command key. Thus, the hand held terminal system automatically determines a data interfacing request specification from the host and selectively loads one of the drivers, allowing the user to interface data with the host without performing the switchover operation of the system.

The personal hand held terminal according to the present invention can not only share general files and personal information management system (PIMS) information with a host using the equipped data sync module, but also can cause all host systems provided with a USB host interface stack to recognize the hand held terminal as a USB mass storage, even when the host is provided with the data sync module, thereby expanding types of devices capable of sharing and interfacing information with the hand held terminal. More particularly, the present invention provides a personal hand held terminal comprising a data interface switchover input key, a data sync driver, a USB client interface, a USB mass storage driver, and a control section. The control section loads a preset USB mass storage driver or a data sync driver by a driver manager in response to an input command or a request received from a USB host. For example, a system/USB mass storage switchover command may be input through the data interface switchover input key. Thereafter, the control section transmits/receives data to/from a USB host via the loaded USB mass storage driver or the loaded data sync driver (as the case may be). For example, if a data transmission/reception request is received from the host based on a USB mass storage specification via the USB client interface in the hand held terminal, the control section transmits/receives data to/from the USB host via the loaded USB mass storage driver. Alternatively, if a data transmission/reception request is received from the host based on a data sync driver specification via the USB client interface in the hand held terminal, the control section transmits/receives data to/from the USB host via the loaded data sync driver. Thus, if the USB host is not provided with a data sync module, it is still possible to share and interface information between both systems, because USB host systems provided with a USB host interface can recognize the personal hand held terminal as a USB mass storage.

Although technical spirits of the present invention has been disclosed with reference to the appended drawings and the embodiments of the present invention corresponding to the drawings has been described, descriptions in the present specification are only for illustrative purposes, and not for limiting the present invention. Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes any foreseeable and/or unforeseeable modifications, additions and substitutions.

What is claimed is:

1. A personal hand held terminal system, comprising:
a USB mass storage driver;
a data sync driver;
a USB interface interfacing data with a USB host;
an input section receiving a system switchover command from a user to cause the USB host to selectively recognize the system as a USB mass storage or a data sync client; and
a control section selectively loading the data sync driver or the USB mass storage driver according to the system switchover command input through the input section, and controlling the system to transmit/receive the data to/from the USB host by the loaded driver and the USB interface.

2. The personal hand held terminal system of claim 1, wherein the control section loads the data sync driver, if a data transmission/reception request is delivered from the USB host based on a data sync module specification while the system is selected to operate as the USB mass storage.

3. The personal hand held terminal system of claim 1, wherein the control section forcibly terminates the loaded USB mass storage driver, if a data transmission/reception request is delivered from the USB host based on a data sync module specification while the system is selected to operate as the USB mass storage.

4. A method of interfacing information of a personal hand held terminal system, comprising:
loading a preset USB mass storage driver, if a system/USB mass storage switchover command is input; and
interfacing data with a USB host via the USB mass storage driver, if a data transmission/reception request is delivered from the USB host according to a USB mass storage specification.

5. The method of claim 4, further comprising:
loading a preset data sync driver, if a data transmission/reception request is delivered from the USB host based on a data sync driver specification while the USB mass storage driver is loaded; and
interfacing the data with the host via the loaded data sync driver.

6. The method of claim 5, wherein the data sync driver is loaded after terminating the loaded USB mass storage driver.

7. A personal hand held terminal system, comprising:
a USB mass storage driver;
a data sync driver;
a USB interface interfacing data with a USB host; and
a control section selectively loading the USB mass storage driver or the data sync driver according to a data transmission/reception specification request from the USB host, and interfacing data with the USB host via the loaded driver and the USB interface.

8. A personal digital assistant, comprising:
a USB interface; and
a USB data driver selecting unit selectively loading USB data drivers in response to a data interface specification request and transmitting/receiving data to/from a USB host via the selected USB data driver driving the USB interface.

9. The personal digital assistant of claim 8, wherein the USB data drivers comprise a USB mass storage data driver and a data sync driver; and
the USB data driver selecting unit selects loading the USB mass storage data driver and/or the data sync driver in response to a user input data interface request or the USB host request, and transmits/receives the data to/from the USB host via the loaded USB data drivers driving the USB interface.

10. The personal digital assistant of claim 8, wherein the USB data drivers comprise a USB mass storage data driver and a data sync driver; and
the USB data driver selecting unit operates the assistant in a USB mass storage mode or in a personal hand held terminal mode according to the respective USB data drivers loaded.

11. A personal digital assistant, comprising:
a USB interface; and
a programmed computer processor controlling the assistant according to a process of:
loading a USB mass storage data driver,
determining if a data sync transmission/reception request is received from a USB host over the USB interface,
unloading the USB mass storage data driver, if determined that the data sync transmission/reception request is received,
loading a data sync driver, and
transmitting/receiving data to/from the USB host via the loaded data sync driver over the USB interface.

12. The personal digital assistant of claim 10, wherein the programmed computer processor further controls the personal digital assistant according to a process of:
determining if a USB mass storage transmission/reception request is received from the USB host over the USB interface;
unloading the data sync driver, if determined that the USB mass storage transmission/reception request is received;
loading the USB mass storage data driver; and
transmitting/receiving data to/from the USB host via the loaded data sync driver over the USB interface.
